(19) United States
(12) Patent Application Publication
(10) Pub. No.: US 2022/0044095 A1
(43) Pub. Date: Feb. 10, 2022

(54) EDGE COMPUTING ARCHITECTURE FOR PRESSURIZED WATER DATA

(71) Applicant: Saya Life, Inc., Los Angeles, CA (US)

(72) Inventors: Sanjay Poojary, Irvine, CA (US); Naveen Kumar Subramani, Monterey Park, CA (US); Chongliang Li, Irvine, CA (US)

(21) Appl. No.: 17/394,685

(22) Filed: Aug. 5, 2021

Related U.S. Application Data
(60) Provisional application No. 63/061,732, filed on Aug. 5, 2020.

(51) Int. Cl. G06N 3/04; G06N 3/08; G06Q 50/06

(52) U.S. Cl. CPC G06N 3/0427; G06Q 50/06; G06N 3/08; G06N 3/0445

(57) ABSTRACT

The present invention is directed to the use of an edge computing architecture to track water usage data, forecast leaks and anomalies related to water in a plumbing system and compile billing information related to said water usage data. The present invention features a water usage tracking system comprising sensors, local computing system, an edge computing system, and a cloud computing system. Sensors may collect raw data at a high frequency and transmit the raw data to the local computing system. The local computing system may receive raw data from the sensors, process the raw data, and transmit and receive decision making data from the edge computing system. The edge computing system may comprise edge servers for collecting and compiling data from local computing systems. The cloud computing system may comprise receiving and deploying a global model to the edge computing system, and tweaking the global model based on feedback.

### CROSS-REFERENCES TO RELATED APPLICATIONS

This application is a non-provisional and claims benefit of U.S. Provisional Application No. 63/061,732 filed Aug. 5, 2020, the specification of which is incorporated herein in their entirety by reference.

### FIELD OF THE INVENTION

The present invention is directed to the use of an edge computing architecture to track water usage data in a plumbing system and compile anomaly detection, risk and consumption forecasting and billing information related to said water usage data.

### BACKGROUND OF THE INVENTION

Currently there is no clear visibility on the behavior of pressurized water once it enters any property although there is an entire economy revolving around water. Property managers and utility companies charge for water use, but tenants have no visibility of how the water was used, if their bill is really accurate and if there were any leaks happening in the pipes. Insurance companies pay out 25% of all their claims on water related issues in residential apartments and homes. Utilities are spending a lot of money in rebate programs and marketing material to influence property owners to reduce consumption and save water. They are also looking to reduce hot water consumption in properties to save energy. 25% of all property claims are water related and insurance companies are also looking for efficient ways to reduce this risk without compromising on customer satisfaction. Tenants and homeowners are sent a water bill every month and there is no visibility for them on what they are paying for and if there are ways to be efficient and save water and money for themselves. Having the knowledge of water including water quality helps reduce water risks and choose the right kind of water quality filter.

There are companies like Flo, Flume, Buoy and Phyn that have solutions for water leak detection, but they are not certified for billing and risk management applications and do not have a gateway for edge computing using data aggregated from different sensors. Thus, a present need exists for a system capable of tracking water usage and leaks, linking this information to water costs, and employing edge computing.

### BRIEF SUMMARY OF THE INVENTION

It is an objective of the present invention to provide systems and methods that allow for an edge computing architecture to track water usage data in a plumbing system and compile billing information related to said water usage data, as specified in the independent claims. Embodiments of the invention are given in the dependent claims. Embodiments of the present invention can be freely combined with each other if they are not mutually exclusive.

The present invention features a water usage tracking system for using a plurality of local water tracking systems to create a global water usage model to be deployed back to the plurality of local water tracking systems. The water usage tracking system may comprise sensors for collecting raw data from a plumbing system and transmitting the raw data to a local computing system. The water usage tracking system may further comprise the local computing system for gathering and processing water usage data and transmitting and receiving water usage data to and from an edge server. The local computing system may comprise a cleaning module, a preprocessing module for converting the cleaned raw data into a plurality of features, and a decision making module for building a water usage model based on the plurality of features and utilizing a set of gathered anomaly data to determine a plurality of potential anomalies. The decision-making module may also be capable of adding the plurality of potential anomalies to the set of gathered anomaly data and alerting a user of the plurality of potential anomalies.

The water usage tracking system may further comprise an edge computing system for compiling water usage data from a plurality of local computing systems and the cloud computing system, and deploying compiled water usage data to both the plurality of local computing systems and the cloud computing system. The edge computing system may comprise a plurality of edge servers and a compilation component.

The water usage tracking system may further comprise the cloud computing system for accepting data from the edge computing system and deploying a global water usage model to the edge computing system to aid a plurality of decision making modules of the plurality of local computing systems. The cloud computing system may comprise a training module for accepting water usage data from the edge computing system and constructing the global model water usage based on the plurality of parameters, a central server for passing the global model to the edge computing system, and a feedback module for compiling the set of gathered anomaly data from the plurality of local computing systems and a plurality of external data sources, gathering the set of gathered anomaly data, and transmitting the set of gathered anomaly data and the water usage behavior to a plurality of external output sources.

The present invention features a method for using a plurality of local water tracking systems to create a global water usage model to be deployed back to the plurality of local water tracking systems. The method may comprise accepting raw data from sensors, using a training data set to clean the raw data, and converting the cleaned raw data into features. The method may further comprise preprocessing the features into a dataset, sending the dataset to an edge computing system, and compiling the dataset into a model in a compilation component of the edge computing system. The method may further comprise fitting the model into a deep learning model, training the deep learning model using historical data, sending the deep learning model to a cloud computing system, and deploying the deep learning model to the edge computing system. The method may further comprise using the deep learning machine learning model to evaluate and predict water usage in the plurality of local water tracking systems in real time. Water usage data collected from the plurality of local water tracking systems may be transmitted to the edge computing systems to be used as the training dataset. Edge AI models are faster, produce minimum carbon emissions, and are thus energy-efficient and green.

The unique model and technology of the present invention allows for working closely with utility companies, insurance companies, and manufacturers, while also providing unique value for tenants and homeowners. The present invention primarily focuses on bringing personalized machine learning models to the data source, rather than bringing the data to the model. This is achieved by doing machine learning at edge. This helps save costs and earns trust from customers. The system of the present invention allows for integration with multiple sensors (air, water, energy, etc) under one roof.

The present invention implements a federated learning framework, which is defined as a feedback loop based on locally collected data, compilation of the said data into a global model, fine tuning based on user feedback, and deployment of the tuned global model back to local systems to ensure constant effective learning of a machine learning model.

One of the unique and inventive technical features of the present invention is a personalized federated learning framework for an Internet of Things (IoT) comprising a plurality of sensors. Without wishing to limit the invention to any theory or mechanism, it is believed that the technical feature of the present invention advantageously provides for subjective feedback loops from customers to improve model performance and provide engaging solutions for all stakeholders in the water economy. None of the presently known prior references or work has the unique inventive technical feature of the present invention. Furthermore, this inventive technical feature is counterintuitive. The reason that it is counterintuitive is because the inventive technical feature contributed to a surprising result. Edge computing is a fairly new concept, and is still currently plagued by latency and memory issues when faced with large amounts of data such as the sets of continuous data produced by prior water data collection systems. Thus, one skilled in the art would choose to avoid edge computing. Surprisingly, reducing the amount of data collected and sending this smaller data set to the edge computing system results in far more accurate and efficient processing of water usage data when compared to large data sets sent directly to the cloud. Essentially, the present invention relies on quality of data rather than quantity. Thus, the technical feature of the present invention contributed to a surprising result and is counterintuitive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a diagram of the various modules and features of the water usage tracking system of the present invention.

FIG. 2 shows a flow chart of a method of the water usage tracking system of the present invention.

FIG. 3 shows a flow chart of processing a plurality of information sources into output in the present invention.

FIG. 4 shows a flow chart of a federated learning process of the present invention.

FIG. 5A shows a flow chart of a method for using a plurality of water usage sensors to create and implement a local predictive water usage model to track water usage. This method can implement federated learning through connection to a cloud server to upload and update the local predictive water usage model based on a congregated global model. FIG. 5B shows a flow chart of the present invention handling anomalies of various severities and training the water usage model accordingly.

### DETAILED DESCRIPTION OF THE INVENTION

Following is a list of elements corresponding to a particular element referred to herein:
100 water usage tracking system
200 cleaning module
300 preprocessing module
400 decision making module
500 feedback module
600 training module
700 central server
800 edge computing system
900 sensors
1000 external application

As used herein, the term “edge server” refers to computing devices that run processing at an edge location, acting as a middleman between local computing systems and a cloud computing system.

As used herein, the term “anomaly” refers to any event that causes a plumbing system to act incorrectly and/or inefficiently. An anomaly may be a leak, a blockage, or any user behavior that may result in a drastic change in water usage, such as a change in weather or a number of people using water over the course of a day.

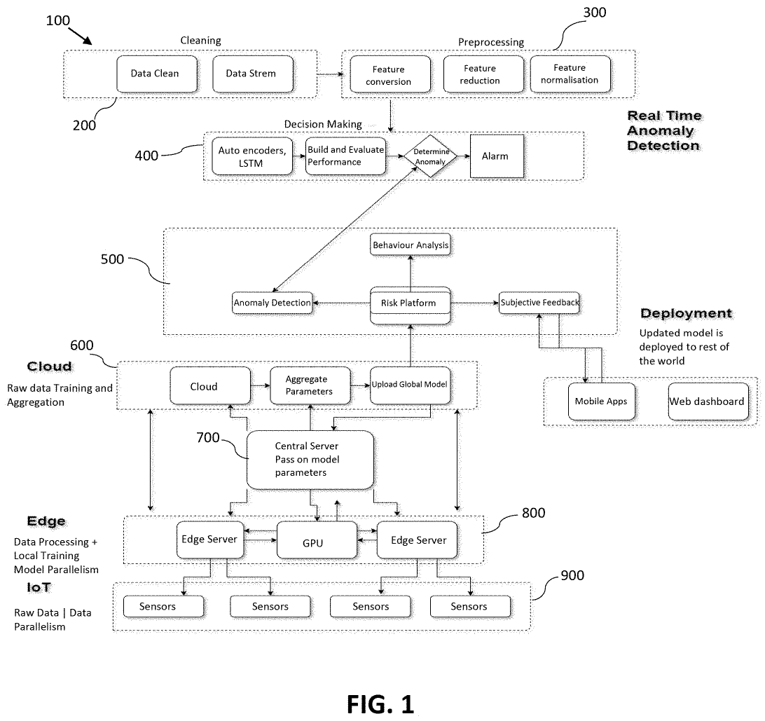

Referring now to FIG. 1, the present invention features a water usage tracking system (100) for tracking local water usage data to generate a global water usage model. In some embodiments, the water usage tracking system (100) may comprise a plurality of sensor groups. Each sensor group may comprise a plurality of sensors (900). Each sensor group may be operatively coupled to a plumbing system. For each sensor group, each sensor of the plurality of sensors (900) may be disposed at different locations along the plumbing system and may be capable of collecting raw data from the plumbing system at a fixed time interval to transmitting the raw data to a local computing system. Each sensor may comprise or be coupled to a water meter capable of measuring flood, energy, humidity, gas, temperature, water quality, and air quality.

The water usage tracking system (100) may further comprise a plurality of local computing systems. Each local computing system may be communicatively coupled to a sensor group. Each local computing system may comprise a first processor capable of executing computer-readable instructions, and a first memory component may comprise a plurality of computer-readable instructions. The first memory component may comprise a cleaning module (200). The cleaning module (200) may comprise instructions for receiving the raw data from the sensor group and cleaning the raw data. The first memory component may further comprise a preprocessing module (300). The preprocessing module (300) may comprise instructions for converting the cleaned raw data into a plurality of features and a set of anomaly data. The first memory component may further comprise a decision making module (400). The decision making module (400) may comprise instructions for building a local water usage model based on the plurality of features. In some embodiments, the local water usage model may comprise a machine learning model. The decision making module (400) may further comprise instructions for predicting, based on the set of anomaly data and the local water usage model, a plurality of potential anomalies, adding the plurality of potential anomalies to the set of anomaly data, alerting a user of each anomaly of the set of anomaly data and transmitting the local water usage model to an edge computing system (800).

The water usage tracking system (100) may further comprise the edge computing system (800) communicatively coupled to the plurality of local computing systems and a cloud computing system. The edge computing system (800) may comprise a plurality of edge servers for receiving the local water usage model and the set of anomaly data from each local computing system of the plurality of local computing systems and receiving a global water usage model and a set of global anomaly data from the cloud computing system. The global water usage model and the set of global anomaly data may be used to retrain the decision making module of each local computing system. The edge computing system (800) may further comprise a second processor capable of executing computer-readable instructions, and a second memory component may comprise a plurality of computer-readable instructions. The second memory component may comprise a compilation module. The compilation module may comprise instructions for compiling a plurality of local water usage models and a plurality of sets of anomaly data from the plurality of edge servers into compiled local data to send to the cloud computing system and sending the compiled local data to the cloud computing system. The compilation module may further comprise instructions for compiling the global water usage model and the set of global anomaly data from the cloud computing system into compiled global data to send to the plurality of edge servers and sending the compiled global data to the plurality of local computing systems.

The water usage tracking system (100) may further comprise the cloud computing system communicatively coupled to the edge computing system (800). The cloud computing system may comprise a third processor capable of executing computer-readable instructions, and a third memory component may comprise a plurality of computer-readable instructions. The third memory component may comprise a training module (600). The training module (600) may comprise instructions for accepting the plurality of local water usage models from the edge computing system (800), aggregating the plurality of local water usage models into a plurality of parameters, constructing the global water usage model based on the plurality of parameters, and transmitting the global water usage model to a central server (700) and a feedback module (500). The cloud computing system may further comprise the feedback module (500). The feedback module (500) may comprise instructions for receiving the plurality of sets of anomaly data from the edge computing system (800), compiling the plurality of sets of anomaly data into the set of global anomaly data, sending the set of global anomaly data to the edge computing system (800), analyzing water usage behavior based on the global water usage model, and transmitting the set of global anomaly data and the water usage behavior to a plurality of external output sources. The cloud computing system may further comprise the central server (700) for passing the global water usage model and the set of global anomaly data to the edge computing system (800) for retraining the plurality of decision making modules (400) of the plurality of local computing systems.

Instructions that cause at least one processing circuit to perform one or more operations are “computer-executable.” Within the scope of the present invention, “computer-readable memory,” “memory component,” and the like comprises two distinctly different kinds of computer-readable media: physical storage media that stores computer-executable instructions and transmission media that carries computer-executable instructions. Physical storage media includes RAM and other volatile types of memory; ROM, EEPROM and other non-volatile types of memory; CD-ROM, CD-RW, DVD-ROM, DVD-RW, and other optical disk storage; magnetic disk storage or other magnetic storage devices; and any other tangible medium that can store computer-executable instructions that can be accessed and processed by at least one processing circuit. Transmission media can include signals carrying computer-executable instructions over a network to be received by a general-purpose or special-purpose computer. Thus, it is emphasized that (by disclosure or recitation of the exemplary term “non-transitory”) embodiments of the present invention expressly exclude signals carrying computer-executable instructions. However, it should be understood that once a signal carrying computer-executable instructions is received by a computer, the type of computer-readable storage media transforms automatically from transmission media to physical storage media. This transformation may even occur early on in intermediate memory such as (by way of example and not limitation) a buffer in the RAM of a network interface card, regardless of whether the buffer's content is later transferred to less volatile RAM in the computer.

In some embodiments, the fixed time interval may be once every 30 to 60 seconds. The plurality of features may comprise water pressure, temperature, flow, and flow rate. The water usage model created by the decision making module (400) comprises a long short-term memory machine learning model. The preprocessing module (300) may further comprise instructions for reducing a size of the plurality of features, and normalizing the plurality of features. In some embodiments, the plurality of external data sources may comprise user feedback, data received from other water tracking systems, and data received from a government. User feedback may be received from a mobile app communicatively coupled to the water usage tracking system (100). User feedback may be received from a web dashboard communicatively coupled to the water usage tracking system (100). In some embodiments, the compilation component may comprise a GPU. The plurality of external output sources may comprise manufacturers, insurance companies, and utility companies.

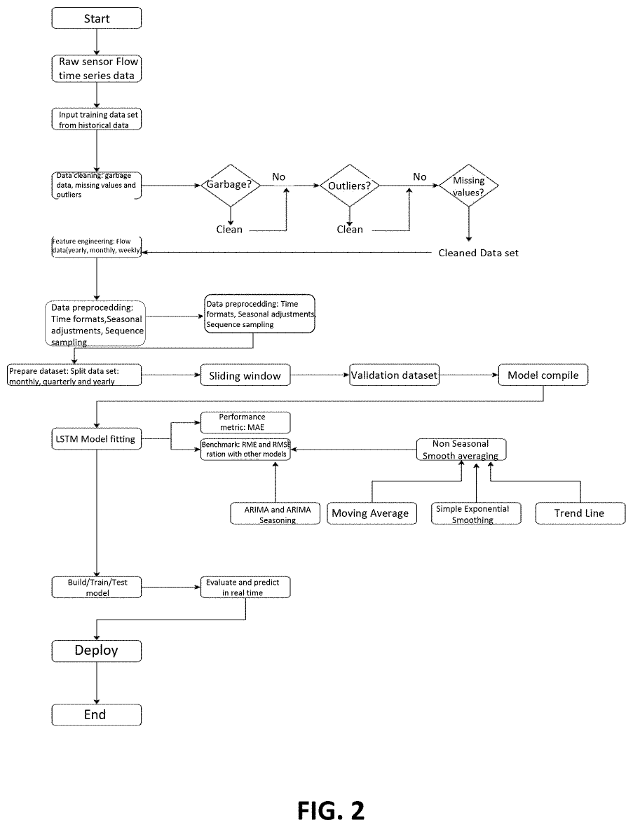

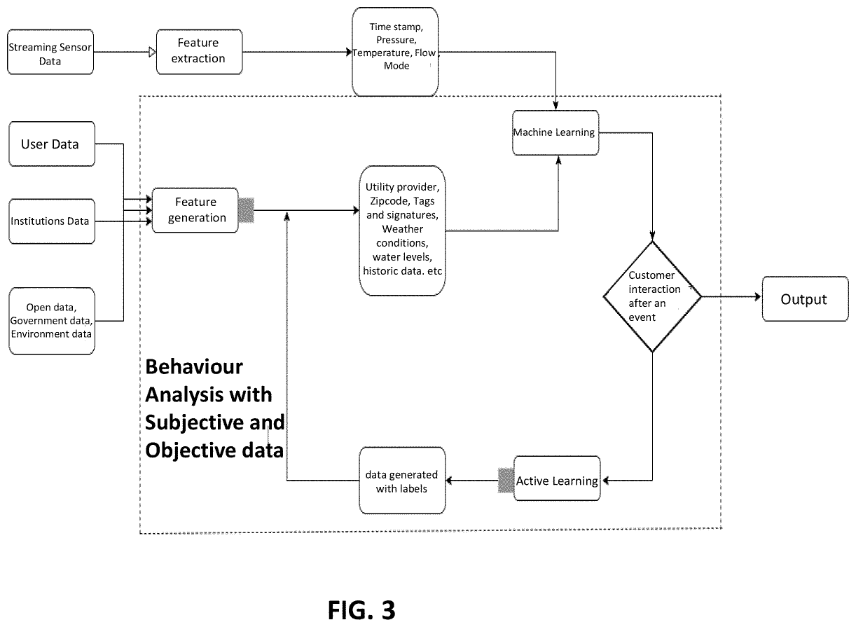

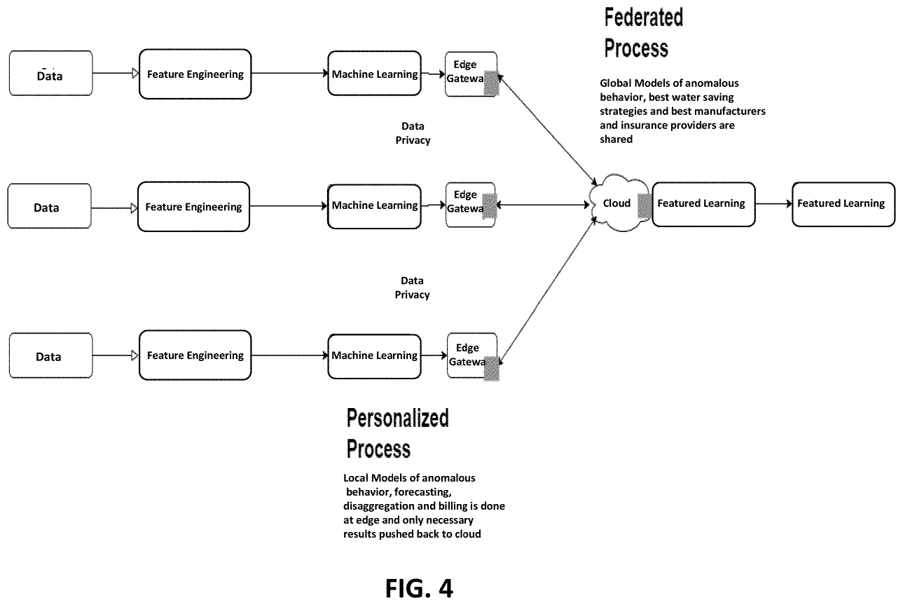

Referring now to FIG. 2, the present invention features a method for using a plurality of local water tracking systems to create a global water usage model to be deployed back to the plurality of local water tracking systems. In some embodiments, the method may comprise accepting raw data from a plurality of sensors (900) gathered at a fixed time interval, using a training data set to clean the raw data, and converting the cleaned raw data into a plurality of features. The method may further comprise preprocessing the plurality of features into a dataset, sending the dataset to an edge computing system (800), and compiling the dataset into a model in a compilation component of the edge computing system (800). The method may further comprise sending the deep learning model to a cloud computing system, fitting the model into a deep learning model, training the deep learning model using historical data, and deploying the deep learning model to the edge computing system (800). The method may further comprise using the deep learning model to evaluate and predict water usage in the plurality of local water tracking systems in real time. Water usage data collected from the plurality of local water tracking systems may be transmitted to the edge computing systems (800) to be used as the training dataset. The deep learning model may comprise a long short-term memory machine learning model, a clustering machine learning model, a graph-based machine learning model, or a combination thereof. The deep learning model may comprise a framework of feature engineering, feedback loops, and a federated learning system. Feature engineering may comprise extracting a plurality of advanced features from the raw data and removing unwanted data. The plurality of advanced features may comprise volume, max flow rate, average flow, seasonality, trends, occupant behavior, zero/low/high consumption points, and duration of an event.

In some embodiments, the fixed time interval may be once every 30 to 60 seconds. The plurality of features may comprise water pressure, temperature, flow, and flow rate. In some embodiments, cleaning the raw data may comprise removing garbage values comprising data values exceeding a maximum threshold and falling below a minimum threshold, and adjusting for missing values that were not correctly collected at the fixed time interval. The maximum threshold may be about 50% greater than a known mean data value (pressure, flow rate, etc.). The minimum threshold may be 0. In some embodiments, preprocessing the plurality of features may comprise fitting the plurality of features into a plurality of time formats and sequence sampling. The plurality of time formats may comprise a monthly format, a quarterly format, a yearly format, and a seasonal format. In some embodiments, compiling the dataset into a model may comprise running the dataset through a sliding window algorithm and validating the dataset. In some embodiments, fitting the model into a deep learning model may comprise calculating a performance metric, calculating a mean absolute error, calculating a benchmark, and calculating a root mean error and a root mean square error. Calculating the benchmark and calculating a root mean error and a root mean square error may comprise utilizing a non-seasonal smooth averaging algorithm. The non-seasonal smooth averaging algorithm may comprise calculating a moving average, utilizing a simple exponential smoothing algorithm, and calculating a trend line. Note that the deep learning model is primarily trained in the cloud server, and is primarily fine tuned and/or retrained in the edge computing system after being sent there. The fine tuned/retrained deep learning models are sent back to the cloud server and used to train the cloud-stored deep learning model. The cloud server primarily stores the majority of deep learning model data, while continuous integration/continuous deployment (CI/CD) versions of the said deep learning models are stored in the edge computing system.

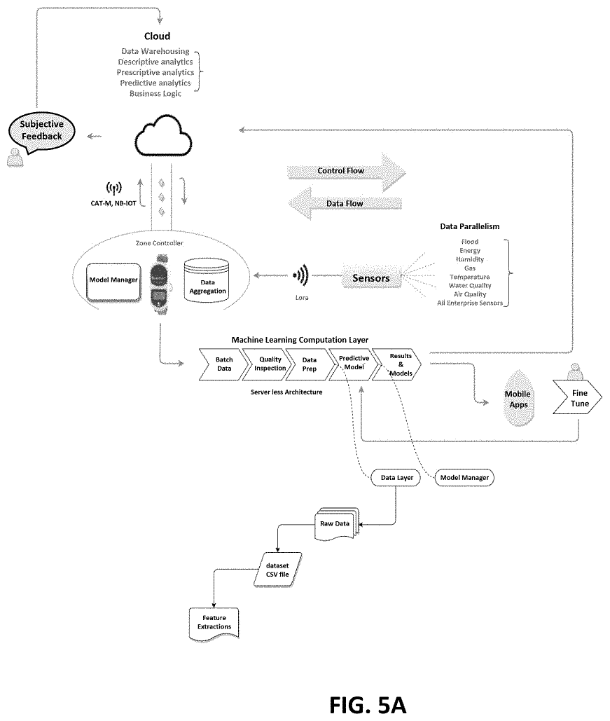

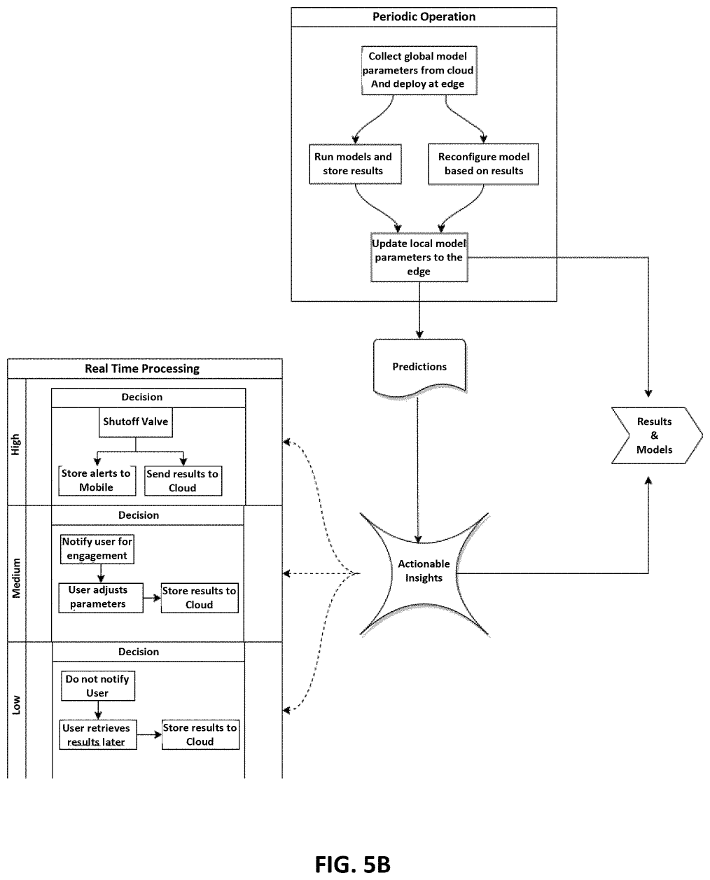

Referring now to FIGS. 5A-5B, the present invention features a method for using a plurality of water usage sensors (900) to create and implement a local predictive water usage model to track water usage. The plurality of water usage sensors (900) may be coupled to a water system. In some embodiments, the method may comprise each water usage sensor collecting raw water usage data from the water system and transmitting the raw water usage data to a zone controller (800) coupled to a water meter. In some embodiments, the raw water usage data may comprise flood, energy, humidity, gas, temperature, water quality, and air quality. In some embodiments, the raw water usage data may be transmitted to the zone controller (800) through a LoRa connection. The method may further comprise the zone controller (800) storing the raw water usage data, processing the raw water usage data into batch data, cleaning the batch data based on a quality inspection, preparing the batch data to be converted into the local predictive water usage model, constructing the local predictive water usage model, and storing the local predictive water usage model in the zone controller (800). In some embodiments, preparing the batch data to be converted into the local water usage model may comprise converting the batch data into a CSV format and extracting a plurality of features from the CSV batch data. The plurality of features may comprise pressure, radiation, and transition.

The method may further comprise the local predictive water usage model identifying a water usage event, and actuating the local predictive water usage model based on a severity of the water usage event. A high risk water usage event may cause the local predictive water usage model to shut off the water system and alert the user, a medium risk water usage event may cause the local predictive water usage model to alert the user, and a low risk water usage event may cause the local predictive water usage model to store data relating to the low risk water usage event. The method may further comprise the zone controller (800) receiving a plurality of global model parameters from a cloud server (700), running a hypothetical model based on the plurality of global model parameters, reconfiguring the local predictive water usage model based on a plurality of results generated by running the hypothetical model, and uploading the local predictive water usage model to the cloud server (700). In some embodiments, the zone controller (800) may be communicatively coupled to an external application (1000). The external application (1000) may avow the user to fine tune parameters of the local predictive water usage model. Data stored in the cloud server (700) may be sent to insurance companies to help them make decisions on policy discounts and rebates for users of water systems. Every local predictive water usage model is sent to the cloud, integrated with all other local predictive water usage models, and the parameters of the integrated model is sent back to all other local predictive water usage models.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A water usage tracking system (100) for tracking local water usage data to generate a global water usage model, the water usage tracking system (100) comprising:
a. a plurality of sensor groups, each sensor group comprising a plurality of sensors (900);
wherein each sensor group is operatively coupled to a plumbing system;
wherein, for each sensor group, each sensor of the plurality of sensors (900) is disposed at different locations along the plumbing system and is capable of collecting raw data from the plumbing system at a fixed time interval and transmitting the raw data to a local computing system;
b. a plurality of local computing systems, wherein each local computing system is communicatively coupled to a sensor group, each local computing system comprising:
i. a cleaning module (200) comprising instructions for:
A. receiving the raw data from the sensor group; and
B. cleaning the raw data, wherein cleaning the raw data comprises removing garbage values comprising data values exceeding a maximum threshold and falling below a minimum threshold, and adjusting for missing values that were not correctly collected at the fixed time interval;
ii. a preprocessing module (300) comprising instructions for:
A. converting the cleaned raw data into a plurality of features and a set of anomaly data; and
iii. a decision making module (400) comprising instructions for:
A. building a local water usage model based on the plurality of features, the local water usage model comprising a machine learning model;
B. predicting, based on the set of anomaly data and the local water usage model, a plurality of potential anomalies;
C. adding the plurality of potential anomalies to the set of anomaly data;
D. alerting a user of each anomaly of the set of anomaly data; and
E. transmitting the local water usage model to an edge computing system (800);
c. the edge computing system (800) communicatively coupled to the plurality of local computing systems and a cloud computing system to allow for federated learning, the edge computing system (800) comprising:
i. a plurality of edge servers for receiving the local water usage model and the set of anomaly data from each local computing system of the plurality of local computing systems and receiving a global water usage model and a set of global anomaly data from the cloud computing system;
wherein the global water usage model and the set of global anomaly data are used to retrain the decision making module of each local computing system; and
ii. a compilation module comprising instructions for:
I. compiling the local water usage models and the sets of anomaly data from the plurality of edge servers into compiled local data to send to the cloud computing system;
II. sending the compiled local data to the cloud computing system;
III. compiling the global water usage model and the set of global anomaly data from the cloud computing system into compiled global data to send to the plurality of edge servers; and
IV. sending the compiled global data to the plurality of local computing systems; and
d. the cloud computing system communicatively coupled to the edge computing system (800) comprising:
i. a training module (600) comprising instructions for:
I. accepting the local water usage models from the edge computing system (800),
II. aggregating the local water usage models into a plurality of parameters,
III. constructing the global water usage model based on the plurality of parameters, and
IV. transmitting the global water usage model to a central server (700) and a feedback module (500); and
ii. the feedback module (500) comprising instructions for:
A. receiving the sets of anomaly data from the edge computing system (800);
B. compiling the sets of anomaly data into the set of global anomaly data;
C. sending the set of global anomaly data to the edge computing system (800);
D. analyzing water usage behavior based on the global water usage model; and
E. transmitting the set of global anomaly data and the water usage behavior to a plurality of external output sources; and
iii. the central server (700) for passing the global water usage model and the set of global anomaly data to the edge computing system (800) for retraining the plurality of decision making modules (400) of the plurality of local computing systems.

2. The water usage tracking system (100) of claim 1, wherein the plurality of features comprises water pressure, temperature, flow, and flow rate.

3. The water usage tracking system (100) of claim 1, wherein the water usage model created by the decision making module (400) comprises a long short-term memory machine learning model.

4. The water usage tracking system (100) of claim 1, wherein the preprocessing module (300) further comprises instructions for:
a. reducing a size of the plurality of features, and
b. normalizing the plurality of features.

5. The water usage tracking system (100) of claim 1, wherein the plurality of external data sources comprises user feedback, data received from other water tracking systems, and data received from a government, wherein user feedback is received from a mobile app or a web dashboard communicatively coupled to the water usage tracking system (100).

6. A method for using a plurality of local water tracking systems to create a global water usage model to be deployed back to the plurality of local water tracking systems, the method comprising:
a. accepting raw data from a plurality of sensors (900) operatively coupled to a plumbing system gathered at a fixed time interval;
b. using a training data set to clean the raw data, wherein cleaning the raw data comprises removing garbage values comprising data values exceeding a maximum threshold and falling below a minimum threshold, and adjusting for missing values that were not correctly collected at the fixed time interval;
c. converting the cleaned raw data into a plurality of features;
d. preprocessing the plurality of features into a dataset;
e. sending the dataset to an edge computing system (800);
f. compiling the dataset into a model in a compilation component of the edge computing system (800);
g. fitting the model into a deep learning model;
h. sending the deep learning model to a cloud computing system;
i. training the deep learning model using historical data;
j. deploying the deep learning model to the edge computing system (800); and
k. using the deep learning model to evaluate and predict water usage in the plurality of local water tracking systems in real time;
wherein water usage data collected from the plurality of local water tracking systems is transmitted to the edge computing systems (800) to be used as the training dataset;
wherein the deep learning model comprises a framework of feature engineering, feedback loops, and a federated learning system.

7. The method of claim 6, wherein the plurality of features comprises water pressure, temperature, flow, and flow rate.

8. The method of claim 6, wherein preprocessing the plurality of features comprises fitting the plurality of features into a plurality of time formats and sequence sampling.

9. The method of claim 6, wherein compiling the dataset into a model comprises running the dataset through a sliding window algorithm and validating the dataset.

10. The method of claim 6, wherein fitting the model into a deep learning model comprises calculating a performance metric, calculating a mean absolute error, calculating a benchmark, and calculating a root mean error and a root mean square error.

11. The method of claim 10, wherein calculating the benchmark and calculating a root mean error and a root mean square error comprises utilizing a non-seasonal smooth averaging algorithm.

12. The method of claim 11, wherein the non-seasonal smooth averaging algorithm comprises calculating a moving average, utilizing a simple exponential smoothing algorithm, and calculating a trend line.

13. The method of claim 6, wherein the deep learning model comprises a long short-term memory machine learning model, a clustering machine learning model, a graph-based machine learning model, or a combination thereof.

14. The method of claim 6, wherein feature engineering comprises extracting a plurality of advanced features from the raw data and removing unwanted data, the plurality of advanced features comprising volume, max flow rate, average flow, seasonality, trends, occupant behavior, zero/low/high consumption points, and duration of an event.

15. A method for using a plurality of water usage sensors (900) to create and implement a local predictive water usage model to track water usage, wherein the plurality of water usage sensors (900) are coupled to a water system, the method comprising:
a. collecting, by each water usage sensor, raw water usage data from the water system;
b. transmitting, by the plurality of water usage sensors (900), the raw water usage data to a zone controller (800) coupled to a water meter;
c. storing, by the zone controller (800), the raw water usage data;
d. processing, by the zone controller (800), the raw ater usage data into batch data;
e. cleaning, by the zone controller (800), the batch data based on a quality inspection, wherein cleaning the raw data comprises removing garbage values comprising data values exceeding a maximum threshold and falling below a minimum threshold, and adjusting for missing values that were not correctly collected at the fixed time interval;
f. preparing, by the zone controller (800), the batch data to be converted into the local predictive water usage model;
g. constructing, the zone controller (800), the local predictive water usage model;
h. storing the local predictive water usage model in the zone controller (800);
i. identifying, by the local predictive water usage model, a water usage event; and
j. actuating the local predictive water usage model based on a severity of the water usage event.

16. The method of claim 15, wherein the raw water usage data comprises flood, energy, humidity, gas, temperature, water quality, and air quality.

17. The method of claim 15, wherein preparing the batch data to be converted into the local water usage model comprises:
a. converting the batch data into a CSV format; and
b. extracting a plurality of features from the CSV batch data;
wherein the plurality of features comprises pressure, radiation, and transition.

18. The method of claim 15 further comprising:
a. receiving, by the zone controller (800), a plurality of global model parameters from a cloud server (700);
b. running a hypothetical model based on the plurality of global model parameters;
c. reconfiguring the local predictive water usage model based on a plurality of results generated by running the hypothetical model; and
d. uploading the local predictive water usage model to the cloud server (700).

19. The method of claim 15, wherein the zone controller (800) is communicatively coupled to an external application (1000), wherein the external application (1000) allows the user to fine tune parameters of the local predictive water usage model.

20. The method of claim 15, wherein a high risk water usage event causes the local predictive water usage model to shut off the water system and alert the user, wherein a medium risk water usage event causes the local predictive water usage model to alert the user, wherein a low risk water usage event causes the local predictive water usage model to store data relating to the low risk water usage event.
